(19) United States
(12) Patent Application Publication
(10) Pub. No.: US 2015/0146628 A1
(43) Pub. Date: May 28, 2015

(54) TECHNIQUES FOR HANDLING RECONFIGURATION MESSAGES AND UPLINK DATA INDICATIONS

(71) Applicant: QUALCOMM Incorporated, San Diego, CA (US)

(72) Inventors: Yongsheng SHI, San Diego, CA (US); Sathish KRISHNAMOORTHY, Hyderabad (IN); Adarsh Kumar JINNU, Hyderabad (IN); Dinesh BILLA, Hyderabad (IN); Ansah Ahmed SHEIK, Hyderabad (IN); Srinivas Reddy ANNEM, Hyderabad (IN); Chetan Gopalakrishnan CHAKRAVARTHY, San Diego, CA (US); Arvindhan KUMAR, San Diego, CA (US)

(21) Appl. No.: 14/323,631

(22) Filed: Jul. 3, 2014

(30) Foreign Application Priority Data
Nov. 26, 2013 (IN) 5431/CHE/2013

(51) Int. Cl. H04W 74/08; H04W 76/04; H04L 5/00

(52) U.S. Cl. CPC H04W 74/0833; H04L 5/0055; H04W 76/046
USPC 370/329

(57) ABSTRACT

Apparatus and methods of wireless communication with a network entity by a user equipment includes identifying, by the user equipment, a change in availability of an enhanced uplink channel. Further, these aspects include waiting for an uplink data indication to trigger a cell update procedure, in response to the identified change in availability of an enhanced uplink channel. Also, these aspects include receiving a reconfiguration message before triggering of the cell update procedure, and receiving the uplink data indication, wherein the uplink data indication corresponds to a Layer 2 Acknowledgement or uplink data. Additionally, these aspects include handling the race condition between the reconfiguration message and the uplink data indication.

### CLAIM OF PRIORITY UNDER 35 U.S.C. §119

The present application for patent claims priority to Indian Patent Application No. 5431/CHE/2013 entitled “APPARATUS AND METHOD OF HANDLING RECONFIGURATON MESSAGES WHEN A USER EQUIPMENT IS WAITING FOR AN UPLINK DATA INDICATION” filed Nov. 26, 2013, and assigned to the assignee hereof and hereby expressly incorporated by reference herein.

### BACKGROUND

Aspects of the present disclosure relate generally to wireless communication systems, and more particularly, to apparatus and methods of managing user equipment (UE) behavior associated with a change in availability of an enhanced uplink channel.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In UMTS, a network can turn on or turn off an enhanced uplink channel, for example, to control allocation of network resources to dedicated wireless communication traffic. For instance, the network may turn on or off a high speed random access channel (HS-RACH) by changing an indicator in a broadcast message, such as a system information block (SIB) 5 or SIB 5bis.

In response, per the current standards and in order to avoid network overload due to the changing availability of the enhanced uplink channel, the UE is required to wait for an uplink data indication, including a Layer 2 Acknowledgement (L2 Ack), before triggering a cell update procedure. However, the current standards do not specify the UE behavior in a scenario where the network sends a reconfiguration message when the UE is waiting for the uplink data indication. As such, the UE behavior in this scenario is undefined, and may lead to an undesired response from the UE.

Thus, improvements in managing user equipment (UE) behavior associated with a change in availability of an enhanced uplink channel are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with some aspects, a method of wireless communication with a network entity by a user equipment is provided. The method includes identifying, by the user equipment, a change in availability of a high-speed random access channel (HS-RACH) provided by the network entity and waiting for an uplink data indication to trigger a cell update procedure, in response to the identified change in availability of the HS-RACH. The method also includes receiving a reconfiguration message from the network entity before triggering of the cell update procedure, receiving the uplink data indication, wherein the uplink data indication corresponds to a Layer 2 Acknowledgement or uplink data, and disregarding the reconfiguration message based at least in part on receiving the uplink data indication.

In accordance with additional aspects, an apparatus for wireless communication with a network entity is provided as well. The apparatus includes a behavior management component configured to identify, by the user equipment, a change in availability of a HS-RACH provided by the network entity, and wait for an uplink data indication to trigger a cell update procedure, in response to the identified change in availability of the HS-RACH. The apparatus also includes a transceiver operable to receive a reconfiguration message from the network entity before triggering of the cell update procedure, and receive the uplink data indication, wherein the uplink data indication corresponds to a Layer 2 Acknowledgement or uplink data. The behavior management component is further configured to disregard the reconfiguration message based at least in part on receiving the uplink data indication.

In accordance with further aspects, an apparatus for wireless communication with a network entity is provided. The apparatus includes means for identifying a change in availability of a HS-RACH provided by the network entity, and means for waiting for an uplink data indication to trigger a cell update procedure, in response to identifying the change in availability of the HS-RACH. The apparatus further includes means for receiving a reconfiguration message from the network entity before triggering of the cell update procedure, means for receiving the uplink data indication, wherein the uplink data indication corresponds to a Layer 2 Acknowledgement or uplink data, and means for disregarding the reconfiguration message based at least in part on receiving the uplink data indication.

Still in accordance with additional aspects, a computer-readable storage medium is provided that includes instructions, that when executed by a processor, cause the processor to perform various steps. The steps include identifying a change in availability of a HS-RACH provided by the network entity, and waiting for an uplink data indication to trigger a cell update procedure, in response to identifying the change in availability of the HS-RACH. The steps also include receiving a reconfiguration message from the network entity before triggering of the cell update procedure, receiving the uplink data indication, wherein the uplink data indication corresponds to a Layer 2 Acknowledgement or uplink data, and disregarding the reconfiguration message based at least in part on receiving the uplink data indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is schematic diagram of an aspect of a UE including a behavior management component as described herein.

FIG. 2 is a flowchart of an aspect of a method of wireless communication by a user equipment.

FIG. 3 is a flowchart of another aspect of a method of wireless communication by a user equipment.

FIG. 4 is a flowchart of another aspect of a method of wireless communication by a user equipment.

FIG. 5 is a flowchart of another aspect of a method of wireless communication by a user equipment.

FIG. 6 is a block diagram illustrating an example of a hardware implementation for an apparatus employing a processing system.

FIG. 7 is a block diagram conceptually illustrating an example of a telecommunications system.

FIG. 8 is a conceptual diagram illustrating an example of an access network.

FIG. 9 is a conceptual diagram illustrating an example of a radio protocol architecture for the user and control plane.

FIG. 10 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Apparatuses and methods described herein relate to various aspects of user equipment (UE) behavior in a scenario where a network sends the UE a reconfiguration message while the UE awaits an uplink data indication after identifying a change in availability of an enhanced uplink channel. Thus, it is possible that the reconfiguration message is received before or shortly after the uplink data indication. According to an aspect, the UE is configured to execute one of the following to prevent a possible race condition between handling the reconfiguration message and handling the uplink data indication: (i) process the uplink data indication, including performing the cell update procedure, and then reject the reconfiguration message; (ii) process the uplink data indication, including performing the cell update procedure, and then ignore the reconfiguration message; (iii) process the uplink data indication, including performing the cell update procedure, and then process or otherwise honor the reconfiguration message; (iv) not process the uplink data indication, including terminating the cell update procedure, and process or otherwise honor the reconfiguration message; and (v) process or otherwise honor the reconfiguration message in the case where the reconfiguration message relates to a voice call, e.g., a paging message associated with a mobile terminated circuit switched (CS) call.

Thus, according to certain described aspects, the behavior of the UE may be controlled, which in some cases can result in reduced processing complexity, and a synchronization of behavior between the UE and the network may be achieved. As used herein, the term “network entity” may refer to substantially any node in a wireless network to which a UE can communicate to facilitate receiving wireless network access. For example, a “network entity” may include a radio transceiver apparatus, a Node B, and/or the like, as described further herein. In addition, the term “enhanced uplink channel,” as used herein, is understood to mean an enhanced uplink channel that a UE can utilize for communicating in a CELL_FACH state in HSPA. For example, an “enhanced uplink channel” may include a High Speed Random Access Channel (HS-RACH), which is a channel over which a UE can request resources from a network entity for communicating in an HSPA network. The term “uplink data indication,” as used herein, is understood to mean an indication received at one communication layer of a network device from another communication device that uplink data is ready for transmission. For example, an “uplink data indication” can include a layer 2 acknowledgement (L2 Ack). In addition, the term “cell update procedure,” as used herein, is understood to mean a procedure to update parameters and/or a state for a UE communicating with a cell for one or more purposes, such as presence of uplink data to transmit, sending a paging response, experiencing radio link failure, performing cell reselection, etc. For example, a “cell update procedure” applied when uplink data is detected (e.g., based on an uplink data indicator) can include a procedure to acquire an identifier (e.g., Enhanced Radio Network Temporary Identity (E-RNTI)) for communicating in a cell.

Furthermore, as used herein, the term “reconfiguration message” can include a message received at a UE to configure communication parameters for communicating in a cell. For example, a “reconfiguration message” can be a radio bearer reconfiguration (e.g., received at a radio resource control (RRC) layer) to configure the UE and/or bearers between the UE and the network, which may result in the UE moving to a communication state, such as CELL_PCH, described further below. In this regard, a “reconfiguration failure message,” as used herein, may include a response from the UE to the reconfiguration message indicating that the UE was unable to or otherwise did not configure the bearers or communication parameters specified in the reconfiguration message. For example, a “reconfiguration failure message” can include a failure message sent at the RRC layer. Additionally, as used herein, the term “reconfiguration status indicator (RSI)” may refer to a flag or other variable included in a message of a cell update procedure indicating whether a reconfiguration is performed (e.g., in response to a received reconfiguration message). An entity receiving a cell update message can check for existence of the RSI to determine whether the UE to which the cell update message relates performed a reconfiguration based on a received reconfiguration message.

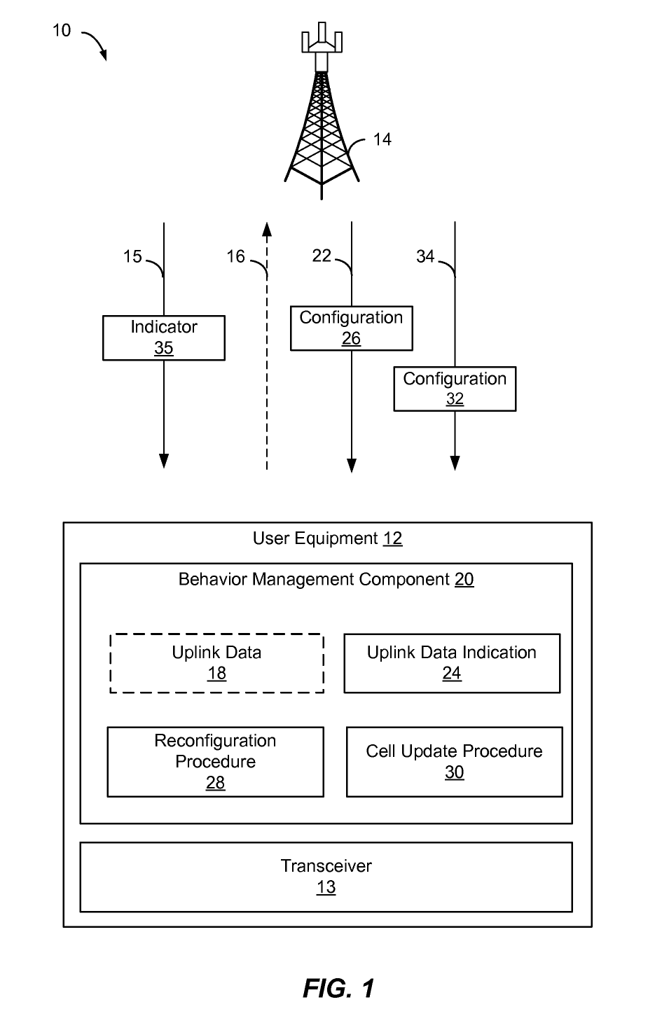

Referring to FIG. 1, in an aspect, a wireless communication network 10 includes a UE 12 communicating via a transceiver 13 with a network entity 14, such as a NodeB. Network entity 14 provides, with varying availability as indicated by a broadcast message 15, an optional enhanced uplink channel 16 to UE 12 for transmitting optionally detected uplink data 18. Network entity 14 may also provide additional enhanced uplink channels 16 for one or more additional UEs 12 (not shown) based on the availability indicated by the broadcast message 15. In the aspects described herein, UE 12 includes a behavior management component 20 configured to control UE behavior in response to identifying a change in the availability of enhanced uplink channel 16, and to further define UE behavior between handling processing of a reconfiguration message 22 and processing an uplink data indication 24. In the Figures described herein, it is to be appreciated that dotted lines indicate optional aspects that may or may not be present in a described apparatus, method, and/or the like. Moreover, in an aspect, a component may be one of the parts that make up a system, may be hardware or software, and/or may be divided into other components.

For example, UE 12 may receive reconfiguration message 22 from network entity 14, where reconfiguration message 22 includes or indicates a configuration 26 for use by UE 12. In an example, the reconfiguration message 22 may define one or more configuration parameters related to transmitting data from the UE 12 to network entity 14. Further, for example, an uplink data indication 24 may be generated within UE 12 by one protocol layer entity to notify another protocol layer entity regarding uplink data for transmitting to network entity 14, which may result in a need to establish a transmission resource. In one instance, for example, uplink data indication 24 may be generated based at least in part on a detected existence of uplink data 18, a request for uplink data 18, and/or the like. Uplink data 18 may be generated by an application executing on UE 12, and may include but is not limited to an uplink Radio Link Control (RLC) data packet data unit (PDU) or an uplink RLC control PDU. In another instance, for example, uplink data indication 24 may be a Layer 2 Acknowledgement (L2 Ack) generated in response to UE 12 receiving reconfiguration message 22 from network entity 14. The reconfiguration message 22 may be sent while the UE 12 is awaiting the uplink data indication 24 or shortly after receiving the uplink data indication 24 (e.g., before a cell update procedure 30 in initiated), and a race condition may occur where the reconfiguration message 22 is received while awaiting the uplink data indication 24 or shortly thereafter.

In this regard, for example, in response to reconfiguration message 22, behavior management component 20 may determine whether to configure UE 12 to perform all or parts of a reconfiguration procedure 28 such to operate according to configuration 26, or to ignore, reject or terminate reconfiguration procedure 28. In addition, in response to receiving uplink data indication 24, behavior management component 20 may determine whether to additionally or alternatively configure UE 12 to perform all or parts of a cell update procedure 30, or to ignore, reject or terminate cell update procedure 30. For example, execution of cell update procedure 30 may result in UE 12 programming itself to operate according to a configuration 32 received from network entity 14 in a cell update confirmation message 34.

For instance, in one example case that should not be construed as limiting, the aspects described herein relate to UE 12 operating in wireless communication network 10 that is a UMTS network, and where UE 12 is operating in a CELL_FACH state (where FACH stands for “Forward Access Channel”). While in this state, UE 12 identifies a change in availability of enhanced uplink channel 16, e.g., a High Speed Random Access Channel (HS-RACH). In this case, for instance, network entity 14 may turn on the HS-RACH (e.g., enable the network entity 14 to receive communications from UEs over resources defined for the HS-RACH) and notify this change to UEs in its coverage area. For example, network entity 14 may indicate enabling of the HS-RACH based at least in part on an indicator 35 in broadcast message 15, e.g., a specific bit having a specific value in a SIB 5 or SIB 5bis message. UE 12 can detect the enabling of the HS-RACH based at least in part on receiving and processing the system information from network entity 14. In response to the identified change in availability of enhanced uplink channel 16, UE 12 waits for uplink data indication 24 to trigger cell update procedure 30.

For instance, performing cell update procedure 30 enables UE 12 to acquire a temporary identifier, such as an Enhanced Radio Network Temporary Identity (E-RNTI), and channel mappings, etc. from the network entity 14, which are used for transmitting uplink data 18. In this example case, while waiting for uplink data indication 24, UE 12 may: (i) receive reconfiguration message 22 from network entity 14, followed by receiving uplink data indication 24; or (ii) receive uplink data indication 24 followed by receiving reconfiguration message 22. In either case, a race condition may exist based on the UE 12 processing the reconfiguration message 22 or the uplink data indication 24 first, since processing one over the other may result in a different resource configuration for the UE 12.

In one example, network entity 14 may send reconfiguration message 22, such as but not limited to a Radio Bearer Reconfiguration, to attempt to cause UE 12 to move from CELL_FACH state to a CELL_PCH state (where PCH stands for “Paging Channel”). In this state, the UE 12 can refrain from transmitting and/or receiving communications with network entity 14 except during specified times where a paging signal may be expected from network entity 14. It should be noted that uplink data indication 24 may be based on UE 12 having uplink data 18, e.g., Dedicated Traffic Channel (DTCH) data, to send or uplink data indication 24 may be a Layer 2 Acknowledgement (L2 Ack), which is a typical response to receipt of reconfiguration message 22. Thus, if the UE 12 is moved to CELL_PCH and receives the uplink data indication 24 shortly thereafter, UE 12 may not process the cell update procedure 30 and/or send the DTCH data since it is in CELL_PCH.

Moreover, if UE 12 receives uplink data indication 24 before receiving reconfiguration message 22, then a protocol layer (e.g., the Radio Resource Control layer) on UE 12 responsible for processing uplink data indication 24 does not know what has triggered cell update procedure 30—the uplink data indication 24 or an acknowledgement for the reconfiguration message 22. Due to this uncertainty, when UE 12 sends a Cell Update message based on receiving the uplink data indication 24, UE 12 may not include or otherwise set a reconfiguration status indicator (RSI) flag. From the perspective of network entity 14, without the RSI, network entity 14 may believe that the reconfiguration message 22 did not reach UE 12 and may assign a new set of configuration parameters, e.g., RNTI's, a target state, mappings, etc., in a Cell Update Confirm message to the UE 12. This may cause UE 12 to obtain two sets of configurations.

It is to be appreciated that the above issues may also be present when UE 12 is in CELL_PCH state and identifies a change in availability of enhanced uplink channel 16 (one difference being that the update cause of the cell update message may change from “cell reselection” in CELL_FACH to “uplink data transmission” in CELL_PCH). Thus, in this example case, UE 12 can also experience a race condition between processing reconfiguration message 22 and processing uplink data indication 24, or a race condition between performing reconfiguration procedure 28 and cell update procedure 30, which could result in unanticipated UE behavior and/or UE 12 and network entity 14 being out of synchronization, e.g., not utilizing the same configuration parameters for communications.

As such, according to various aspects described herein, in the above-noted scenario where a race condition exists between processing reconfiguration message 22 and processing uplink data indication 24 after UE 12 has identified a change in availability of enhanced uplink channel 16, behavior management component 20 may configure or otherwise control UE 12 to execute one of the following: (i) process uplink data indication 24, including performing cell update procedure 30, and then reject reconfiguration message 22; (ii) process uplink data indication 24, including performing cell update procedure 30, and then ignore reconfiguration message 22; (iii) process uplink data indication 24, including performing cell update procedure 30, and then process or otherwise honor the reconfiguration message 22; (iv) not process uplink data indication 24, including terminating cell update procedure 30, and process or otherwise honor the reconfiguration message 22; and (v) process or otherwise honor reconfiguration message 22 in the case where reconfiguration message 22 relates to a voice call, e.g., a paging message associated with a mobile terminated CS call.

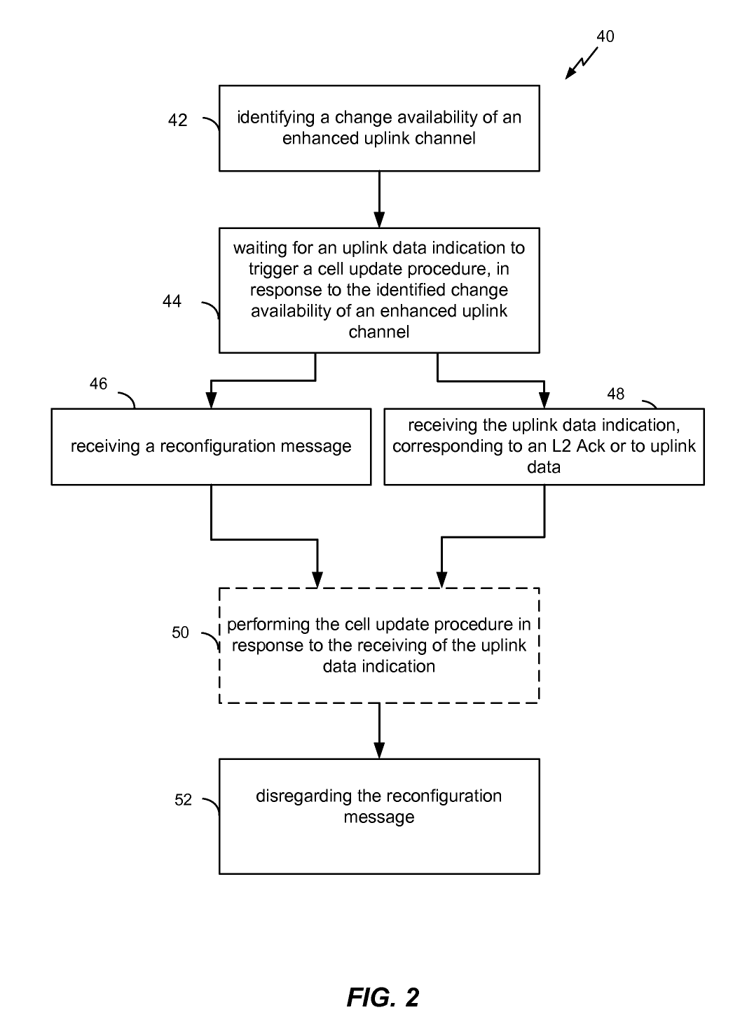

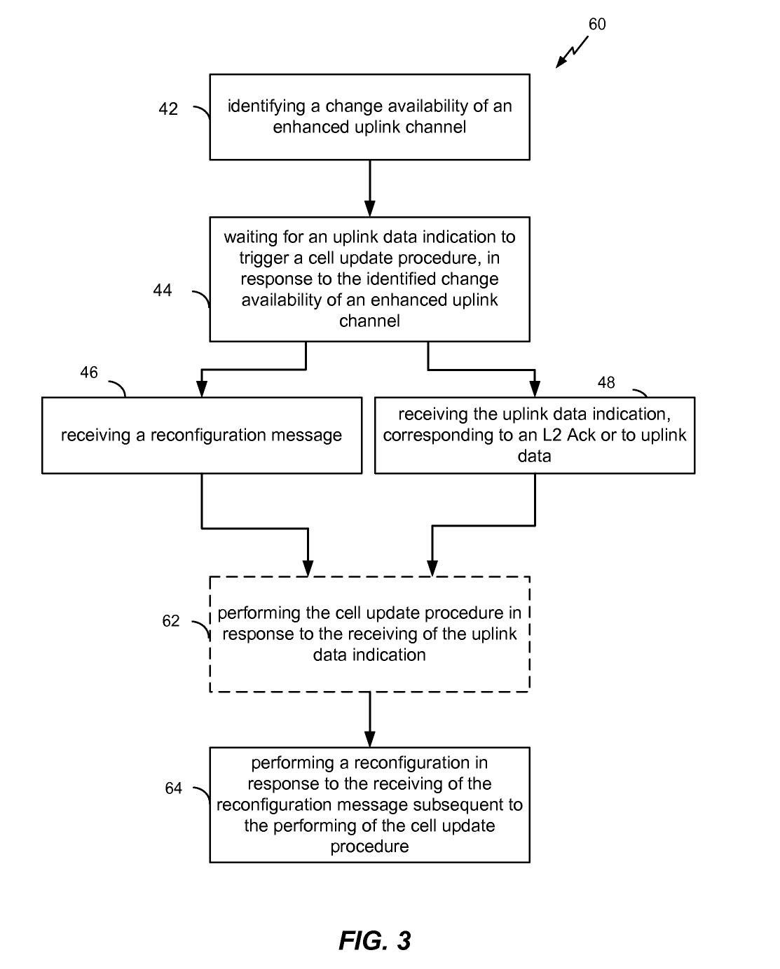

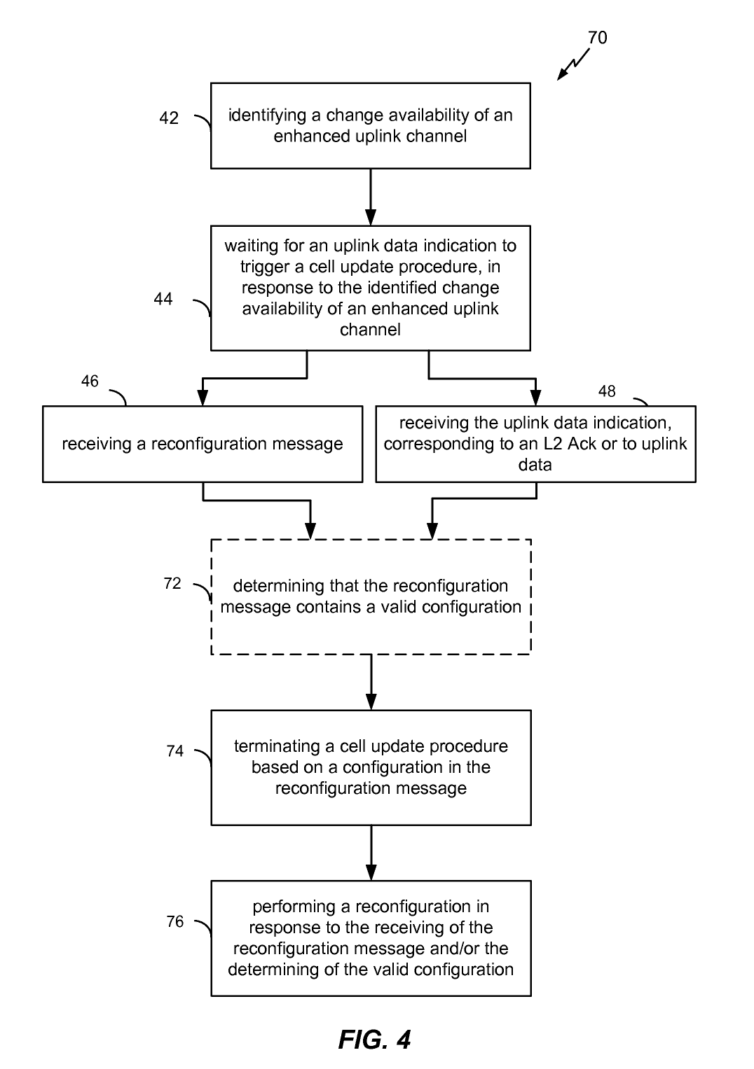

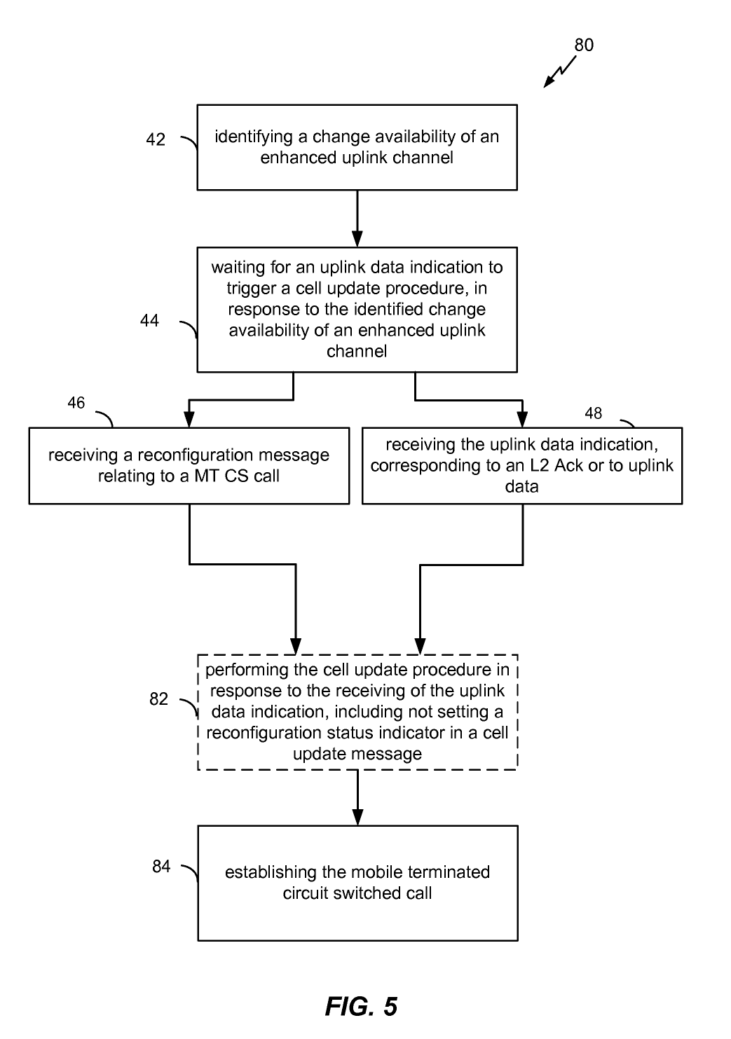

Referring to FIGS. 2-5, different operational aspects of behavior management component 20 (FIG. 1) may execute different methods of preventing the potential race condition that may exist between processing reconfiguration message 22 and processing uplink data indication 24 after UE 12 has identified a change in availability of enhanced uplink channel 16. For instance, in the aspect of FIG. 2, the method includes processing cell update procedure 30, and then disregarding reconfiguration message 22 and/or reconfiguration procedure 28. As used herein, the term “disregarding” may include either rejecting (e.g., by communicating a rejection message) or ignoring, and more specifically in this case results in reconfiguration procedure 28 resulting in, or being interpreted (by network entity 14) as, a failure. Further, for example, in the aspect of FIG. 3, the method includes processing cell update procedure 30, and then processing reconfiguration message 22 and/or reconfiguration procedure 28. Also, for instance, in the aspect of FIG. 4, the method includes terminating cell update procedure 30, and then processing reconfiguration message 22 and/or reconfiguration procedure 28. Finally, for instance, in the aspect of FIG. 5, the reconfiguration message relates to a mobile terminated CS (MT CS) call, and the method includes performing cell update procedure 30, and establishing a call. Optionally, in each of the methods of FIGS. 2-5, uplink data 18, such as DTCH data, may arrive at a protocol entity on UE 12 and uplink data 18 may be transmitted from UE 12 to network entity 14.

Referring specifically to FIG. 2, in an aspect, a method 40 of wireless communication with a network entity by a UE includes performing a cell update procedure and then disregarding a reconfiguration message and/or a reconfiguration procedure.

In particular, at Block 42, method 40 may include identifying a change availability of an enhanced uplink channel. For example, in an aspect, UE 12 and/or behavior management component 20 may be notified of or may obtain indicator 35 from broadcast message 15, such as via receipt and processing of broadcast message by transceiver 13. For instance, behavior management component 20 may identify a change in availability of an enhanced uplink channel 16, such as based on a value of indicator 35 within the broadcast message 15, or based on a change of value of indicator 35, such as based on a comparison with a stored value of a previously received indicator. In an aspect, indicator 35 may include but is not limited to, a READY FOR COMMON EDCH variable where the broadcast message 15 may be a SIB 5 or SIB 5bis message.

Further, at Block 44, method 40 may include waiting for an uplink data indication to trigger a cell update procedure, in response to the identified change availability of an enhanced uplink channel. For example, in an aspect, UE 12 and/or behavior management component 20 may monitor for uplink data indication 24, which may be received by one or more layers of the UE 12 to indicate that uplink data is present for transmitting over an uplink channel to a network entity. Thus, monitoring for the uplink data indication 24 may include monitoring the one or more layers for indications received therefrom. For instance, UE 12 and/or behavior management component 20 may cause an RRC protocol layer entity on UE 12 to register L2 for an uplink data indication.

At Block 46, method 40 may include receiving a reconfiguration message, which may occur while waiting for the uplink data indication at Block 44 and/or otherwise before triggering of the cell update procedure (e.g., shortly after receiving an uplink data indication). For example, in an aspect, UE 12 and/or behavior management component 20 may receive or otherwise receive notice of receipt of reconfiguration message 22, for example, from network entity 14. For instance, transceiver 13 may receive reconfiguration message 22 and pass all or part of reconfiguration message 22 up the protocol stack of UE 12. It is to be appreciated that, typically, receipt of reconfiguration message 22 requires generation of an L2 Ack in response. Moreover, as described, the reconfiguration message may be received, at Block 46, based at least in part on the change in availability of the enhanced uplink channel.

At Block 48, method 40 may include receiving the uplink data indication, wherein the uplink data indication corresponds to a Layer 2 Acknowledgement (L2 Ack) or uplink data. For example, in an aspect, UE 12 and/or behavior management component 20 may receive or otherwise receive notice of receipt of uplink data indication 24, which may be an L2 Ack in response to receipt of reconfiguration message 22 (or a prior reconfiguration message) or which may be an indication related to actual uplink data 18. For instance, the RRC protocol layer entity on UE 12 may receive L2 Ack or a notice regarding requested uplink data based on the registration.

Optionally, at Block 50, method 40 may include performing the cell update procedure in response to the receiving of the uplink data indication. In an aspect, UE 12 and/or behavior management component 20 may initiate cell update procedure 30 with the cell update cause of “cell reselection” if UE 12 is in CELL_FACH state or “uplink data transmission” if UE 12 is in CELL_PCH state based at least in part on receiving uplink data indication 24. Moreover, in an aspect, UE 12 and/or behavior management component 20 may generate and may cause transmission of a cell update message transmitted as part of the cell update procedure 30 (e.g., by transceiver 13), but without setting the RSI flag as part of the cell update procedure 30. For example, UE 12 and/or behavior management component 20 may be configured to avoid setting RSI flag, as the RRC protocol layer entity may not be able to identify whether uplink data indication 24 corresponds to an L2 Ack of a reconfiguration message, or to actual uplink data 18. In this example, the network entity 14 can detect that the RSI flag is not set, and can determine that the UE 12 is not reconfiguring to the CELL_PCH state. Additionally, performing the cell update procedure at Block 50 can include UE 12 or cell update procedure 30 receiving a Cell Update Confirm Message from the network entity 14 (e.g., via transceiver 13), and/or sending a L2 Ack to the network based on a configuration included in the Cell Update Confirm Message.

It is to be appreciated that the actions of Block 46 and Block 48 may occur in any order. As such, in some cases uplink data indication 24 may be received first by the RRC protocol layer entity, while in other cases reconfiguration message 22 may be received first by the RRC protocol layer entity. In either case, the receipt of both uplink data indication 24 and reconfiguration message 22 may cause a race condition within UE 12 in conventional implementations, as described above. Thus, without using aspects described herein, unspecified UE behavior may be caused with respect to performing one or both of cell update procedure 30 and reconfiguration procedure 28.

As such, at Block 52, method 40 may include disregarding the reconfiguration message. For example, in an aspect, UE 12 and/or behavior management component 20 may send a reconfiguration failure message to network entity 14 using the cause “cell update occurred.” According to this example, network entity 14 may receive the reconfiguration failure message with the cause (e.g., along with the lack of RSI in the cell update message), and determine that UE 12 rejected the reconfiguration message 22. As such, network entity 14 may send another reconfiguration message later. Alternatively, for example, in another aspect, UE 12 and/or behavior management component 20 may ignore reconfiguration message 22 and not execute reconfiguration procedure 28. According to this example, as UE 12 does not set the RSI, as described above, network entity 14 can interpret this as reconfiguration message 22 being not successfully received by UE 12 based on receiving the cell update message without the set RSI. As such, there may be no need for UE 12 to send a failure message, and UE 12 or behavior management component 20 may refrain from doing so, in one example. Again, in this example, network entity 14 may send another reconfiguration message later.

Optionally, although not illustrated, it should be noted that method 40 may further include receiving uplink data 18. For example, in an aspect, uplink data 18 in the form of an uplink RLC data PDU or an RLC control PDU or any DTCH data may arrive at RRC protocol layer entity. In response, method 40 may start transmitting uplink data 18, e.g., according to configuration 32 associated with cell update procedure 30 and cell update confirmation message 34. As described, UE 12 may transmit the uplink data 18 using transceiver 13.

Thus, the examples according to method 40 enable UE 12 and/or behavior management component 20 to control the response to UE 12 in a predictable fashion, and without consequence as to the potential race condition described above.

Referring specifically to FIG. 3, in another aspect, a method 60 of wireless communication with a network entity by a UE performs a cell update procedure and then processes a reconfiguration message.

In particular, method 60 includes Blocks 42, 44, 46, and 48, as described above with respect to method 40 (FIG. 2).

Optionally, at Block 62, method 60 may perform the cell update procedure, but unlike Block 50 (FIG. 2), performing the cell update procedure in Block 62 may include setting or not setting a RSI in a cell update message depending on a timing of the receiving of the reconfiguration message relative to a timing of the receiving of the uplink data indication. For example, in an aspect, UE 12 and/or behavior management component 20 may set or not set the RSI depending on whether the RRC protocol layer entity determines that uplink data indication 24 is based on receipt of reconfiguration message 22. Thus, for example, if the reconfiguration message 22 is received before the time the cell update procedure 30 is performed, UE 12 and/or behavior management component 20 may set the RSI. Similar to Block 50, however, performing the cell update procedure, at Block 62, may include receiving the Cell Update Confirm message 34 from network entity 14 (e.g., via transceiver 13), and in response sending an L2 Ack to network entity 14 based on configuration 32 included in Cell Update Confirm message 34.

At Block 64, method 60 may include performing a reconfiguration in response to the receiving of the reconfiguration message subsequent to the performing of the cell update procedure. For example, in an aspect, UE 12 and/or behavior management component 20 may execute reconfiguration procedure 28 to reconfigure UE 12 to operate according to configuration 26 associated with reconfiguration message 22. In particular, UE 12 sends a reconfiguration complete message to network entity 14 (e.g., via transceiver 13) and applies configuration 26 received in reconfiguration message 22, even if configuration 32 in Cell Update Confirm message 34 may be different than the one in reconfiguration message 22. Thus, the reconfiguration message 22 is processed after the uplink data indication 24 regardless of which is received first.

Optionally, although not illustrated, it should be noted that method 60 may further include receiving uplink data 18. For example, in an aspect, uplink data 18 in the form of an uplink RLC data PDU or an RLC control PDU or any DTCH data may arrive at RRC protocol layer entity. In response, method 60 may start transmitting uplink data 18 (via transceiver 13), e.g., according to configuration 26 associated with reconfiguration message 22.

Thus, the example according to method 60 enables UE 12 and/or behavior management component 20 to control the response to UE 12 in a predictable fashion, however, UE 12 has a risk to accept and handle two sets of configurations (e.g., configuration 26 from reconfiguration message 22 and configuration 32 from Cell Update Confirm message 34). Such a solution may increase complexity at the UE.

Referring specifically to FIG. 4, in another aspect, a method 70 of wireless communication with a network entity by a UE terminates the cell update procedure and then processes a reconfiguration message.

In particular, method 70 includes Blocks 42, 44, 46, and 48, as described above with respect to method 40 (FIG. 2).

At Block 72, after receiving the reconfiguration message, method 70 may include determining that the reconfiguration message contains a valid configuration. For example, in an aspect, UE 12 and/or behavior management component 20 may execute a procedure to validate configuration 26 according to the rules defined in 3GPP TS 25.331. For example, this can include verifying that the configuration 26 includes certain parameters, conforms to a specific format, and/or the like.

Further, at Block 74, method 70 may include terminating a cell update procedure based on a configuration in the reconfiguration message. For example, in an aspect, UE 12 and/or behavior management component 20 may stop execution of cell update procedure 30 when configuration 26 from reconfiguration message 22 is determined to be valid, and/or based on receiving the configuration 26 in the reconfiguration message 22 in the first place.

At Block 76, method 70 may include performing a reconfiguration in response to the receiving of the reconfiguration message and/or the determining of the valid configuration. For example, in an aspect, UE 12 and/or behavior management component 20 may execute reconfiguration procedure 28 based on receiving the configuration 26 and/or based on determining configuration 26 from reconfiguration message 22 is valid. As such, UE 12 and/or behavior management component 20 may apply configuration 26 to UE 12 and send the L2 Ack and a reconfiguration complete message to network entity 14 (e.g., via transceiver 13).

Optionally, although not illustrated, it is to be appreciated that method 70 may further include receiving uplink data 18. For example, in an aspect, uplink data 18 in the form of an uplink RLC data PDU or an RLC control PDU or any DTCH data may arrive at RRC protocol layer entity. In response, method 70 may start transmitting uplink data 18 (via transceiver 13), e.g., according to configuration 26 associated with reconfiguration message 22.

Thus, the solution according to method 70 enables UE 12 and/or behavior management component 20 to control the response to UE 12 in a predictable fashion, however, this solution may result in unintended behavior at network entity 14 because, according to the specification of 3GPP TS 25.331, network entity 14 would expect to receive a Cell Update message from UE 12. In this regard, network entity 14 may be configured to accept a reconfiguration complete message without also receiving a Cell Update message as indicating the UE 12 is using the configuration 26.

Referring specifically to FIG. 5, in another aspect, a method 80 of wireless communication with a network entity by a UE, where the reconfiguration message relates to a MT CS call, includes performing a cell update procedure and establishing a call.

In particular, method 80 includes Blocks 42, 44, 46, and 48, as described above with respect to method 40 (FIG. 2), except that at Block 46 the reconfiguration message relates to a MT CS call. For instance, the MT CS call may be a Paging Type 2 call, and thus the reconfiguration message received at Block 46 may relate to preparing the UE 12 to receive the MT CS call via network entity 14. This can include establishing a dedicated channel between the network entity 14 and UE 12 for the call, for example. It is to be appreciated that receiving the reconfiguration message 22 can include receiving the message 22 using transceiver 13. The apparatus and methods described herein may configure UE 12 and behavior management component 20 to avoid rejecting such a call where uplink data indication 24 is received shortly before or after the reconfiguration message 22.

Accordingly, at Block 82, method 80 includes performing the cell update procedure in response to the receiving of the uplink data indication, including not setting a RSI in a cell update message. Similar to Block 50, however, performing the cell update procedure, at Block 82, may include receiving the Cell Update Confirm message 34 from network entity 14 (e.g., via transceiver 13), and in response sending an L2 Ack to network entity 14 based on configuration 32 included in Cell Update Confirm message 34.

At Block 84, method 80 includes establishing the MT CS call. For example, in an aspect, UE 12 and/or behavior management component 20 may execute a call establishment procedure based on the reconfiguration message 22 relating to the MT CS call. For instance, UE 12, which may be initiated by a Non-Access Stratum (NAS) entity, may send an Initial Direct Transfer message to network entity 14 (e.g. via transceiver 13) to setup the CS signaling.

Optionally, although not illustrated, it should be noted that method 80 may further include receiving uplink data 18. For example, in an aspect, uplink data 18 in the form of an uplink RLC data PDU or an RLC control PDU or any DTCH data may arrive at RRC protocol layer entity. In response, method 80 may start transmitting uplink data 18 (via transceiver 13), e.g., according to configuration 26 associated with reconfiguration message 22.

Thus, the solution according to method 80 enables UE 12 and/or behavior management component 20 to accept and establish an MT CS call.

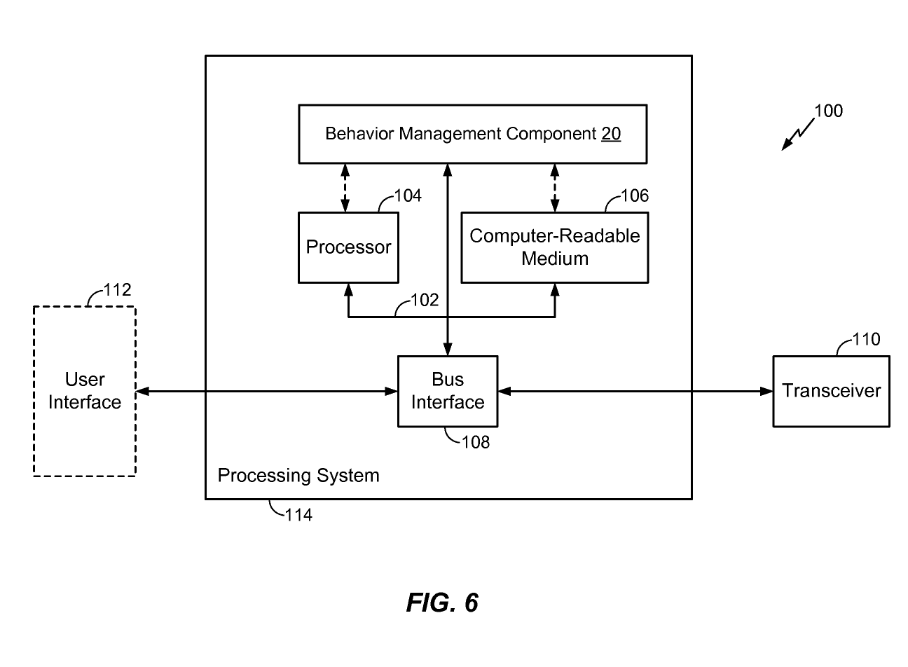

Referring to FIG. 6, an example of a hardware implementation for an apparatus 100 employs a processing system 114 for executing behavior management component 20 (FIG. 1) to perform the functions described herein. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

In an aspect, processor 104, computer-readable medium 106, or a combination of both may be configured or otherwise specially programmed to perform the functionality of the behavior management component 20, components thereof, or various other components described herein. For example, processor 104, computer-readable medium 106, or a combination of both may be configured or otherwise specially programmed to perform the functionality of the behavior management component 20 described herein, and/or the like.

The various concepts presented throughout this disclosure may be implemented across a broad variety of telecommunication systems, network architectures, and communication standards.

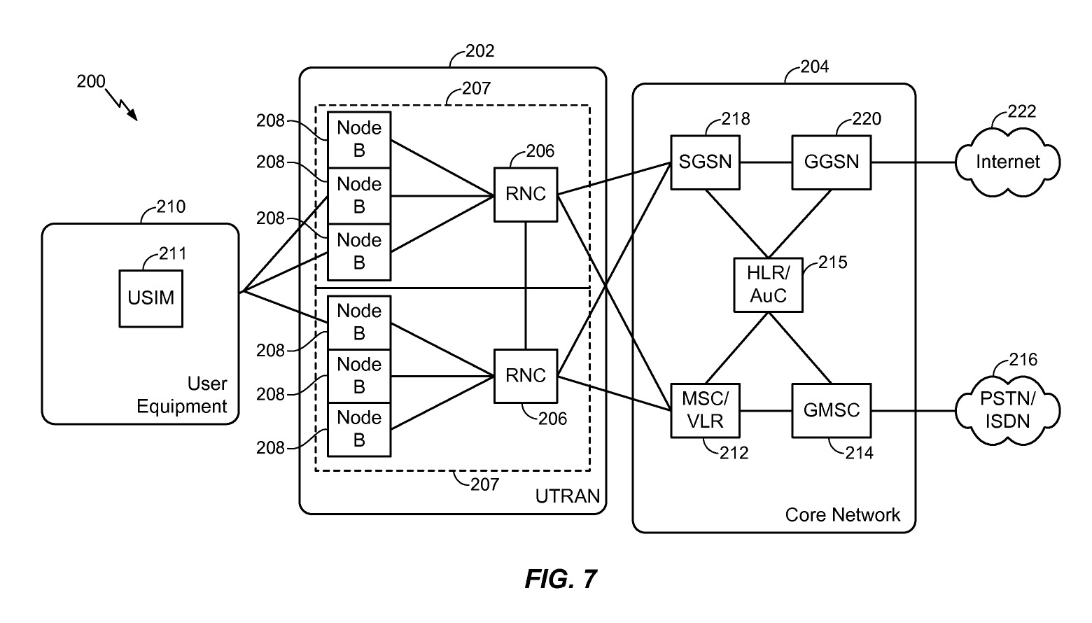

Referring to FIG. 7, by way of example and without limitation, aspects described herein are presented with reference to a UMTS system 200 employing a W-CDMA air interface with which UE 210, which may include behavior management component 20 (FIG. 1) and which may be the same as or similar to UE 12, may communicate. A UMTS network includes three interacting domains: a Core Network (CN) 204, a UMTS Terrestrial Radio Access Network (UTRAN) 202, and UE 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In addition, with the Internet of Things/Everything becoming more prevalent in the future, it would be beneficial to include not just the traditional mobile device, but other types of devices as a mobile apparatus or UE, such as a watch, a personal digital assistant, a personal monitoring device, a machine monitoring device, a machine to machine communication device, etc. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

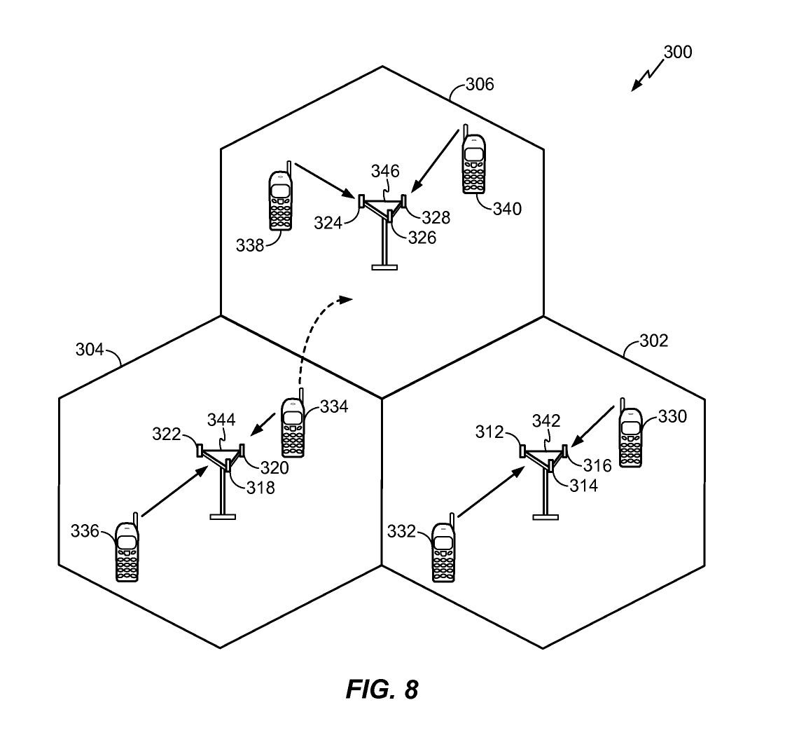

Referring to FIG. 8, an access network 300 in a UTRAN architecture is illustrated and includes one or more UEs that may execute behavior management component 20 (FIG. 1) as described herein. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206, or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

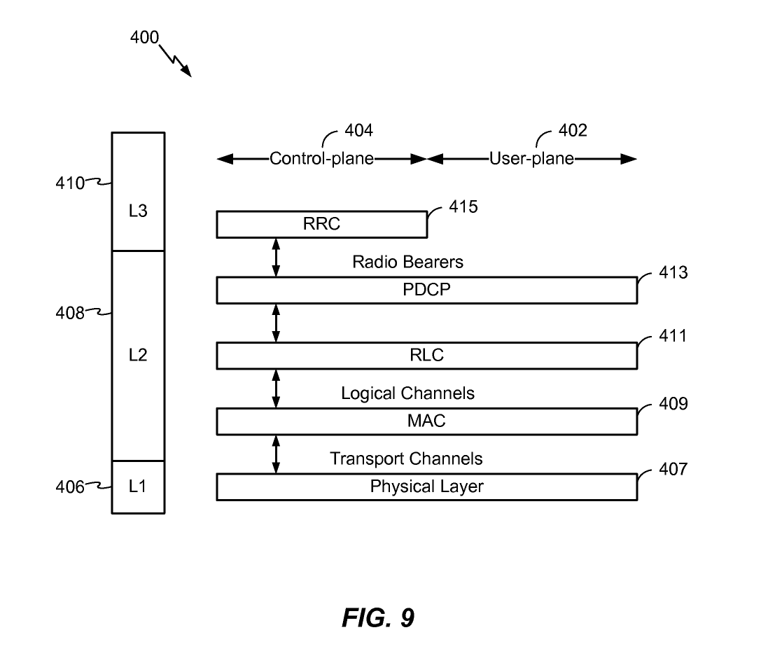

The radio protocol architecture may take on various forms depending on the particular application. An example for an HSPA system will now be presented with reference to FIG. 9.

Referring to FIG. 9, an example radio protocol architecture 400 relates to the user plane 402 and the control plane 404 of a user equipment (UE) or node B/base station. For example, architecture 400 may be included in a UE such as UE 12 executing behavior management component 20 (FIG. 1). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

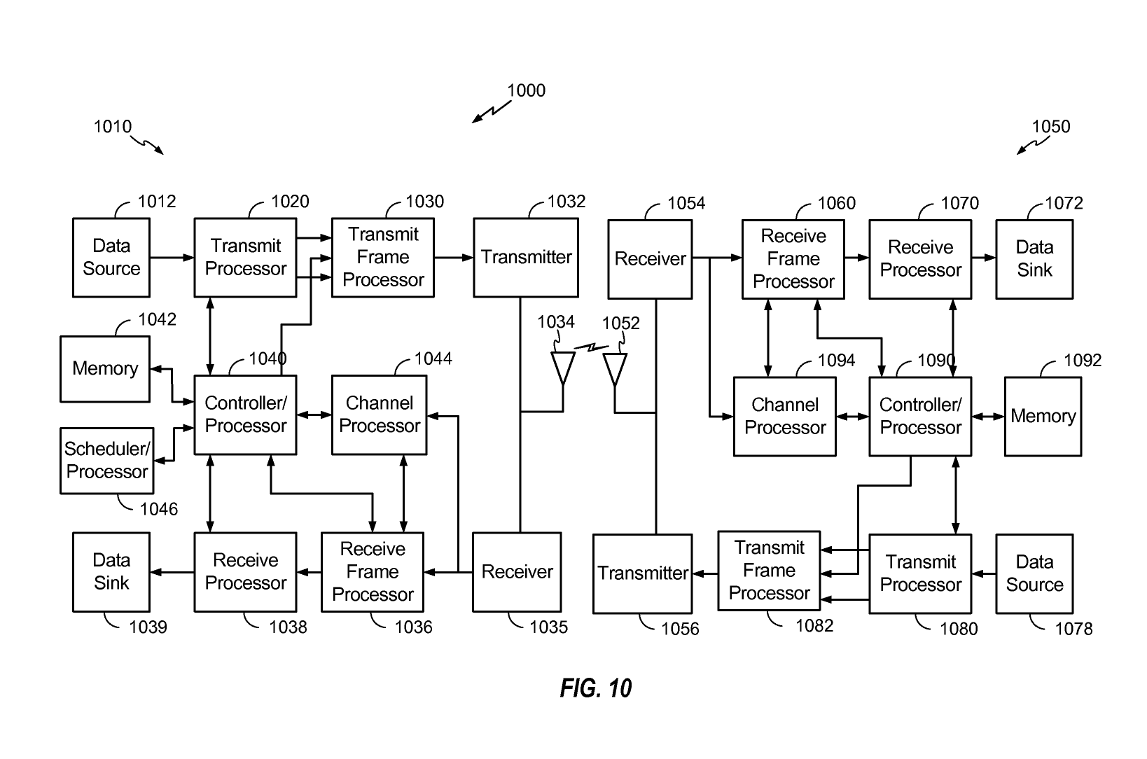

Referring to FIG. 10, an aspect of a Node B 1010 in communication with a UE 1050, where the Node B 1010 may network entity 14 in FIG. 1, and UE 1050 may be UE 12 executing behavior management component 20 in FIG. 1. In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and despreads the symbols, and then determines the most likely signal constellation points transmitted by the Node B 1010 based on the modulation scheme. These soft decisions may be based on channel estimates computed by the channel processor 1094. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication with a network entity by a user equipment, comprising:
identifying, by the user equipment, a change in availability of a high-speed random access channel (HS-RACH) provided by the network entity;
waiting for an uplink data indication to trigger a cell update procedure, in response to identifying the change in availability of the HS-RACH;
receiving a reconfiguration message from the network entity before triggering of the cell update procedure;
receiving the uplink data indication, wherein the uplink data indication corresponds to a Layer 2 Acknowledgement or uplink data; and
disregarding the reconfiguration message based at least in part on receiving the uplink data indication.

2. The method of claim 1, wherein the disregarding of the reconfiguration message comprises sending a reconfiguration failure message to the network entity.

3. The method of claim 2, further comprising performing the cell update procedure in response to the receiving of the uplink data indication.

4. The method of claim 2, further comprising performing the cell update procedure in response to the receiving of the uplink data indication, the performing including not setting a reconfiguration status indicator in a cell update message.

5. The method of claim 1, wherein the disregarding of the reconfiguration message comprises ignoring the reconfiguration message.

6. The method of claim 5, further comprising performing the cell update procedure in response to the receiving of the uplink data indication.

7. The method of claim 1, further comprising:
receiving uplink data subsequent to the receiving of the uplink data indication;
performing the cell update procedure in response to the receiving of the uplink data indication, including not setting a reconfiguration status indicator in a cell update message; and
transmitting the uplink data upon completion of the cell update procedure.

8. The method of claim 1, wherein identifying the change in availability of the HS-RACH is based at least in part on a value in a broadcast message received from the network entity.

9. The method of claim 1, wherein the Layer 2 Acknowledgement corresponds to an acknowledgement of receiving the reconfiguration message.

10. An apparatus for wireless communication with a network entity, comprising:
a behavior management component configured to identify a change in availability of a high-speed random access channel (HS-RACH) provided by the network entity, and wait for an uplink data indication to trigger a cell update procedure, in response to identifying the change in availability of the HS-RACH; and
a transceiver operable to receive a reconfiguration message from the network entity before triggering of the cell update procedure, and receive the uplink data indication, wherein the uplink data indication corresponds to a Layer 2 Acknowledgement or uplink data,
wherein the behavior management component is further configured to disregard the reconfiguration message based at least in part on receiving the uplink data indication.

11. The apparatus of claim 10, wherein the behavior management component is configured to disregard the reconfiguration message by sending a reconfiguration failure message to the network entity.

12. The apparatus of claim 11, wherein the behavior management component is further configured to perform the cell update procedure in response to the receiving of the uplink data indication.

13. The apparatus of claim 11, wherein the behavior management component is further configured to perform the cell update procedure in response to the receiving of the uplink data indication, the performing including not setting a reconfiguration status indicator in a cell update message.

14. The apparatus of claim 10, wherein the behavior management component is configured to disregard the reconfiguration message by ignoring the reconfiguration message.

15. The apparatus of claim 14, wherein the behavior management component is further configured to perform the cell update procedure in response to the receiving of the uplink data indication.

16. The apparatus of claim 10, wherein the transceiver is operable to receive uplink data subsequent to the receiving of the uplink data indication, the behavior management component is further configured to perform the cell update procedure in response to the receiving of the uplink data indication, including not setting a reconfiguration status indicator in a cell update message, and the transceiver is operable to transmit the uplink data upon completion of the cell update procedure.

17. The apparatus of claim 10, wherein the behavior management component is configured to identify the change in availability of the HS-RACH based at least in part on a value in a broadcast message received from the network entity.

18. The apparatus of claim 10, wherein the Layer 2 Acknowledgement corresponds to an acknowledgement of receiving the reconfiguration message.

19. An apparatus for wireless communication with a network entity, comprising:
means for identifying a change in availability of a high-speed random access channel (HS-RACH) provided by the network entity;
means for waiting for an uplink data indication to trigger a cell update procedure, in response to identifying the change in availability of the HS-RACH;
means for receiving a reconfiguration message from the network entity before triggering of the cell update procedure;
means for receiving the uplink data indication, wherein the uplink data indication corresponds to a Layer 2 Acknowledgement or uplink data; and
means for disregarding the reconfiguration message based at least in part on receiving the uplink data indication.

20. The apparatus of claim 19, wherein the means for disregarding disregards the reconfiguration message by sending a reconfiguration failure message to the network entity.

21. The apparatus of claim 20, further comprising means for performing the cell update procedure in response to the receiving of the uplink data indication.

22. The apparatus of claim 20, further comprising means for performing the cell update procedure in response to the receiving of the uplink data indication, wherein the means for performing performs the cell update procedure at least in part by transmitting a cell update message without setting a reconfiguration status indicator in the cell update message.

23. The apparatus of claim 19, wherein the means for disregarding disregards the reconfiguration message by ignoring the reconfiguration message.

24. The apparatus of claim 23, further comprising means for performing the cell update procedure in response to the means for receiving the uplink data indication receiving the uplink data indication.

25. A computer-readable storage medium, comprising instructions, that when executed by a processor, cause the processor to perform the steps of:
identifying a change in availability of a high-speed random access channel (HS-RACH) provided by the network entity;
waiting for an uplink data indication to trigger a cell update procedure, in response to identifying the change in availability of the HS-RACH;
receiving a reconfiguration message from the network entity before triggering of the cell update procedure;
receiving the uplink data indication, wherein the uplink data indication corresponds to a Layer 2 Acknowledgement or uplink data; and
disregarding the reconfiguration message based at least in part on receiving the uplink data indication.

26. The computer-readable storage medium of claim 25, wherein disregarding the reconfiguration message comprises sending a reconfiguration failure message to the network entity.

27. The computer-readable storage medium of claim 26, further comprising instructions, that when executed by the processor, cause the processor to perform the step of performing the cell update procedure in response to the receiving of the uplink data indication.

28. The computer-readable storage medium of claim 26, further comprising instructions, that when executed by the processor, cause the processor to perform the step of performing the cell update procedure in response to the receiving of the uplink data indication at least in part by transmitting a cell update message without setting a reconfiguration status indicator in the cell update message.

29. The computer-readable storage medium of claim 25, wherein disregarding the reconfiguration message comprises ignoring the reconfiguration message.

30. The computer-readable storage medium of claim 29, further comprising instructions, that when executed by the processor, cause the processor to perform the step of performing the cell update procedure in response to the means for receiving the uplink data indication receiving the uplink data indication.
